(19) United States
(12) Patent Application Publication
(10) Pub. No.: US 2003/0214142 A1
(43) Pub. Date: Nov. 20, 2003

(54) Apparatus for lifting and laying a masonry step

(76) Inventor: Anthony Barreto, Cliffside Park, NJ (US)

Correspondence Address: Thomas L. Adams, 120 Eagle Rock Avenue, P.O. Box 340, East Hanover, NJ, 07936, US

(21) Appl. No.: 10/150,629

(22) Filed: May 17, 2002

(51) Int. Cl. B65G 7/12

(52) U.S. Cl. 294/62; 294/16

(57) ABSTRACT

A masonry step lifter has a first and a second jaw. Each of the jaws has (a) a tong adapted to subjacently support the masonry step, and (b) an upper and a lower arm. The upper arms overlap to an adjustable extent, as do the lower arms. The lower arms are releasably interlockable. The first jaw has a support leg with a lower portion attached to the proximal end of the tong for the first jaw. The support leg has an upper portion attached to the arms of the first jaw. The upper portion is inwardly set back to provide over the tong of the first jaw clearance for other overhanging masonry steps. The arms of the first and the second jaw are sized to avoid overhanging the upper portion of the support leg. The jaws can straddle the masonry step before being brought together in order to insert the tongs under the masonry step, and lift the masonry step. Using the jaws, the masonry step is laid on one of the horizontal surfaces of a stepped foundation. The jaws are then separated to remove at least an inward one of the tongs from under the masonry step.

### BACKGROUND OF THE INVENTION

1. Field of the Invention

The present invention relates to apparatus and methods for laying masonry steps, and in particular, to techniques that take into account the clearance and security needed for such purposes.

2. Description of Related Art

To build masonry steps, a mason first builds a stepped foundation having a number of alternating horizontal and vertical surfaces. Thereafter, starting from the top, the mason will lay a layer of cement and place a masonry step on the cement. This process will be repeated for the next level down until all of the masonry steps have been laid in place. Each masonry step is typically spaced from the foundation's adjacent vertical face, and the gap is filled with cement.

These masonry steps are usually lifted into place by hand. Typically, a pair of masons will lift the masonry step at either end, but this process is difficult and may be extremely difficult where the masonry step must fit between flanking walls.

Masonry limestone steps are offered in 6, 8, 10, 12, or 14 inch (15, 20, 25, 31, or 36 cm) widths, 12 inches being the most popular width. The steps are typically 2 inches (5.1 cm) thick and common in various lengths that are often trimmed to accommodate a particular installation.

To avoid pinching fingers, the masonry step is usually dropped from a small height, but this tends to disturb the underlying cement layer. Some masons will lower the masonry step into place with ropes, but this leaves voids in the cement when the ropes are pulled free.

The masonry steps are normally sized to overhang. This overhanging reduces the clearance when installing the next masonry step down.

In U.S. Pat. No. 1,141,038 a pair of hooks can slide in one direction on bar 8, while an opposing pair of hooks slide on bar 7 in the opposite direction. Cables 24 are used to bring the opposing hooks together while cables 25 bring them apart. This grappling device would not be suitable for lifting masonry steps into place because bars 6, 7 and 8 extend outside the grasp of the hooks. Thus a mason would not have sufficient clearance to bring a masonry step close to one of the vertical surface on a stepped foundation.

In U.S. Pat. No. 2,828,618 bars 15 can be depressed to swing legs 1 and insert lugs 3 under a masonry block in order to grapple and lift the block. The legs do not lock in place and are therefore relatively insecure. The spacing between plates 18 can be adjusted by sliding collars 8 and 20 on bars 10, but only slightly because this adjustment will also swing arms 1 and change the depth of insertion of lugs 3.

In U.S. Pat. No. 673,937 lifting handle 6 swings tong 5 to drive bricks 1 against tong 9. The tongs do not provide subjacent support and will be relatively insecure. See also U.S. Pat. No. 370,565.

In U.S. Pat. No. 2,652,278 a pair of opposing jaws can fit around one of the webs of a building block. By lifting the device with its handle, the jaws rotate and dig into the web so that the block can be lifted. This device provides no subjacent support and is therefore relatively insecure. U.S. Pat. No. 2,541,863 shows a similar device where the spacing between the jaws can be adjusted. For other similar devices see U.S. Pat. Nos. 2,808,286; 2,967,730; 4,463,979; and 4,982,987. See also the related devices for holding a pipe (U.S. Pat. No. 2,378,454); or a box (U.S. Pat. No. 615,355).

U.S. Pat. No. 1,805,604 shows a simple grappling device. See also U.S. Pat. Nos. 408,380 and 5,692,789.

Accordingly, there is need for improved apparatus and methods for securely lifting a masonry step in such a way that the step can be laid in place without interfering with previously laid steps.

### SUMMARY OF THE INVENTION

In accordance with the illustrative embodiments demonstrating features and advantages of the present invention, there is provided a masonry step lifter with a first and a second jaw. Each of the jaws has a tong adapted to subjacently support the masonry step. The tongs each have an inwardly directed distal end and a proximal end. Each of the first and the second jaw has an arm. The arms of the first and the second jaw overlap to an adjustable extent and are releasably interlockable. The first jaw has a support leg with a lower portion attached to the proximal end of the tong for the first jaw. The support leg has an upper portion attached to the arm of the first jaw. The upper portion is inwardly set back to provide over the tong of the first jaw clearance for other overhanging masonry steps. The arms of the first and the second jaw are sized to avoid overhanging the upper portion of the support leg.

According to another aspect of the invention, a masonry step lifter is provided with a first and a second jaw that are releasably interlockable. Each of the jaws has a tong adapted to subjacently support the masonry step. Each of the first and the second jaw has an upper and a lower arm. The upper arms of the first and the second jaws overlap to an adjustable extent. The lower arms of the first and the second jaws overlap to an adjustable extent.

In accordance with another aspect of the invention a method is provided for laying a masonry step with first and second spatially adjustable jaws onto a stepped foundation having an alternating plurality of horizontal and vertical surfaces. Each of the jaws has a lower tong. The method includes the step of straddling the masonry step with the jaws. The method also includes the steps of bringing the jaws together in order to insert the tongs under the masonry step, and lifting the jaws to raise the masonry step. Another step is using the jaws to lay the masonry step on one of the horizontal surfaces with an inward one of the tongs close to an adjacent one of the vertical surfaces. The method also includes the steps of separating the jaws to remove at least the inward one of the tongs from under the masonry step, and lifting at least the inward one of the tongs.

By employing apparatus and methods of the foregoing type, an improved technique is achieved for moving a masonry step into place. In a preferred embodiment, a pair of jaws each have upright legs that are integral with upper horizontal arms. These upper arms overlap and are slidably attached together, with one arm attached by a pair of studs to a slot in the other arm. The preferred jaws each have attached at the mid points of the legs, lower horizontal arms. Posts in one of the lower arms slide in a slot in the other lower arm. Preferably, a notched lever attached to one of the jaws can lock onto the posts to keep the jaws set at a desired spacing. The mouth of the notches in this lever may be larger than the posts to guide the posts and to allow a small freedom of movement that tolerates variations in the dimensions of the masonry step.

The preferred jaws may have a spring that biases them together. Tongs at the bottom of the legs of the jaws can hook underneath the masonry step. Thereafter, the jaws can be lifted in order to hoist the masonry step in place on a layer of cement on a stepped foundation. Once the masonry step is laid in place, the jaws can be separated and removed. In the preferred embodiment, the inward leg has an upper portion that is set back to provide clearance around an overhanging masonry step on the next level up.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a perspective view of a masonry step lifter in accordance with principles of the present invention, with the masonry step shown in phantom;

FIG. 2 is a bottom view of the lifter of FIG. 1;

FIG. 3 is a side elevational view of a lifter that is an alternative to that of FIG. 1;

FIG. 4 is a detailed, perspective, fragmentary view of a portion of the lifter of FIG. 3, showing the handle attachment;

FIG. 5 is a perspective view of a lifter that is an alternative to that of FIG. 1;

FIG. 6 is a side elevational view of the locking lever of FIG. 5;

FIG. 7 is a detailed, perspective, fragmentary view of the pivot joint of the locking lever of FIG. 5;

FIG. 8 is a plan view of one of the lower arms of FIG. 5;

FIG. 9 is a detailed, perspective, fragmentary view of a shuttle locking mechanism that is an alternative to the locking lever of FIG. 6; and

FIGS. 10A and 10B are cross-sectional views of a stepped foundation showing various stages in the installation of a masonry step with a schematically illustrated lifter.

### DETAILED DESCRIPTION OF THE PREFERRED EMBODIMENTS

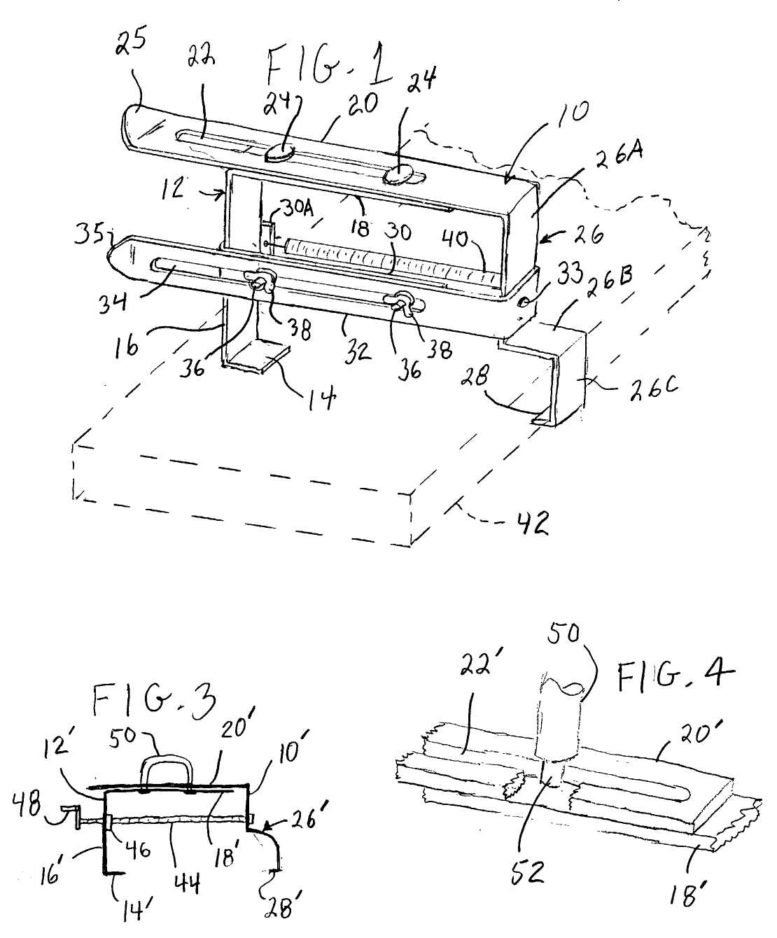

Referring to FIGS. 1 and 2, a masonry step lifter is shown with a first jaw 10 and second jaw 12. Jaw 12 is shown as a flat bar that is bent into a “J” shape. Specifically, jaw 12 has a horizontal tong 14, a vertical straight back leg 16, and a horizontal upper arm 18. Arm 18 is a flat bar that overlaps another flat bar, namely, upper arm 20 of first jaw 10. Arm 20 has over most of its length a slot 22. A pair of studs 24 are affixed to upper arm 18 and protrude through slot 22. Studs 24 are bolt-like, that is, a shank topped by a disk-like head.

The end 25 of upper arm 20 is tapered and bent upwardly to form a distal hand grip. The opposite end of arm 20 connects to an integral support leg 26, which has an upper vertical portion 26A, a lower vertical portion 26B, and between them a horizontal step portion 26. The proximal end of tong 28 is integrally attached to the bottom of portion 26C. The proximal end of tong 14 is integrally attached to the bottom of leg 16. The distal ends of tongs 14 and 28 point inwardly toward each other and are shaped as flat blades. While the dimensions can vary in alternative embodiments, here tong 14 is about 1⅛ inches (2.9 cm) long and tong 28 is shorter (about ½ inch or 1.3 cm long) for reasons described hereinafter.

A lower arm 30 is shown as a flat J-shaped bar forming a hook-like structure that is attached to the outside of straight leg 16. The longest branch of bar 30 is overlapped by another J-shaped bar, namely, lower arm 32. Lower arm 32 hooks around and is secured to the outside of upper portion 26A of leg 26. The hooked ends of arms 30 and 32 are attached by a pin (e.g., pin 33) that is secured with a cotter pin (shown in further detail hereinafter).

The end 35 of arm 32 is tapered and bent to form a distal hand grip. A slot 34 extends along most of the length of the longest branch of arm 32. A pair of threaded studs 36 affixed to arm 30 extends through slot 34. Wing nuts 38 are threaded onto studs 36 to releasably clamp arms 30 and 32 together. The ends of threaded studs 36 may be peened to prevent removal of the wing nuts. Also, wing nuts 38 will be installed with a regular washer and lock washer.

Arms 18 and 30 are overlapped by arms 20 and 32, respectively, and cannot extend past leg 26, even when jaws 10 and 12 are brought together to their minimum spacing. The use of upper and lower arms increases the overall strength of the lifter in comparison to a device that used only upper arms.

Arms 18 and 30 are about 8½ inches (21.6 cm) long and arms 20 and 32 are about 13 to 13½ inches (33.0 to 34.3 cm) long although other lengths will be used for other embodiments designed to handle wider or narrow were masonry steps. In particular, the illustrated embodiment is designed to grapple masonry steps that are either 10, 12, or 14 inches (25, 31, or 36 cm) wide, although other embodiments could be dimensioned to handle a different number of standard step widths. Since masonry steps are also offered in standard 6 and 8 inch (15 and 20 cm) widths, a smaller embodiment is contemplated to handle these narrower steps. Also, the lifter is preferably about 7½ inches (19.1 cm) tall, although different heights may be employed in other embodiments, depending on the expected step size, required clearance, desired strength, etc. For the most part the various structural components are made from flat steel bar, although components made of different material and having alternative dimensions and shapes may be used instead. Preferably, jaws 10 and 12 are made of bar stock that is 2 inches (5.1 cm) wide and ⅛ inch (3.2 mm) thick, and arms 30 and 32 of bar stock with the same thickness and a width that is 1¼ to 1½ inches(3.2 to 3.8 cm), although other dimension may be employed in other embodiments.

The hooks 40A of extension spring 40 are connected between the shortest branches 30A and 30B of arms 30 and 32, respectively, to pull the jaws 10 and 12 together. Spring 40 is sometimes referred to as a yielding means and can cause tongs 14 and 28 to slip underneath masonry step 42, which is shown in phantom.

The foregoing arrangement is most convenient for right handed users. To accommodate left-handed users, arms 30 and 32 can be mounted on the opposite side of the lifter. Arm 32 is removed from leg 26 by releasing fastener 33 by extracting cotter pin 37. Arm 30 will be removed from leg 16 by removing a similar fastener and cotter pin (not shown). Thereafter, arms 30 and 32 can be reinstalled on the opposite side of the lifter, with the position of spring 40 thereby reversed.

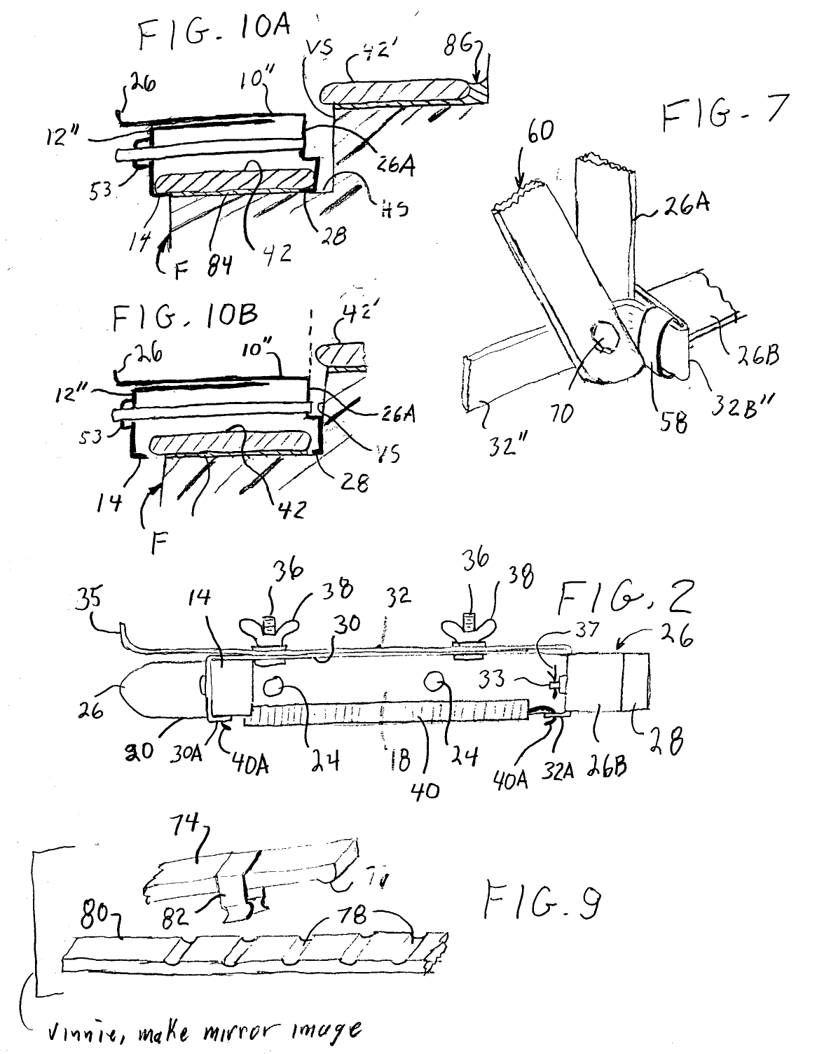

Referring to FIGS. 3 and 4, components in this schematically illustrated, alternative lifter that correspond to components in the lifter previously illustrated in FIGS. 1-2 have the same reference numerals but marked with a prime (′). In this embodiment the previously illustrated lower arms (arms 30 and 32) were eliminated and replaced with lead screw 44. Screw 44 is threaded into nut 46, which is secured to leg 16′ of jaw 12′. Jaw 10′ is rotatably secured to one end of lead screw 44. The other end of screw 44 is attached to manual crank 48, which can be rotated to thread the screw 44 through nut 46 and move jaw 10′ relative to jaw 12′. Because screw 44 provides less reinforcement than the previously mentioned cross-arms (arms 30 and 32 of FIG. 1), the stock of jaws 10′ and 12′ is increased. Preferably, jaws 10′ and 12′ are made of stock that is 2 inches (5.1 cm) wide and 3/16 inch (4.8 mm) thick.

The previously illustrated studs (studs 24) are replaced in this embodiment with arched handle 50. The two ends of handle 50 are narrowed into studs 52 that fit inside slot 22′ of arm 20′. The overall height of this device, excluding handle 50, is preferably 7¾ inches (19.7 cm), although this height may be different in alternate embodiments.

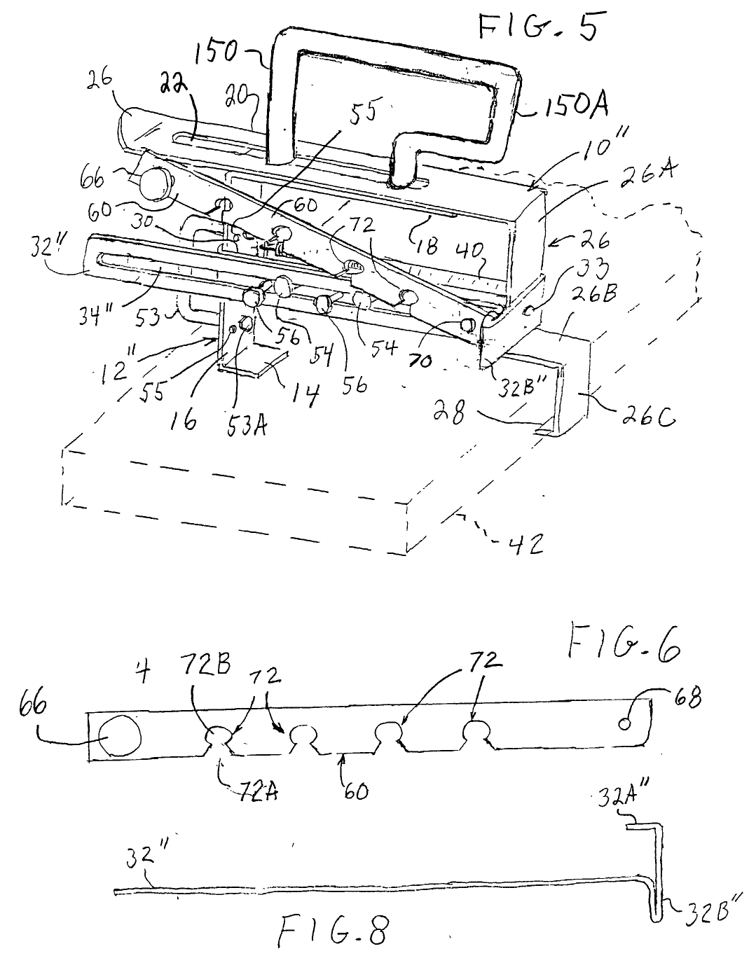

Referring to FIGS. 5-8, components that are the same as those shown in FIGS. 1-2 bear the same reference numerals. Modified components that correspond to those shown in FIGS. 1-2 bear the same reference numerals but marked with a double prime (″). Accordingly, jaw 12″ has a similar J-shaped structure and includes tong 14, straight leg 16, and upper arm 18. An arched handle 53 is attached to the outside of leg 16.

The previously illustrated studs (studs 24) are replaced in this embodiment with arched handle 150. In the same manner as shown in FIG. 4, the two ends of handle 150 are narrowed into studs that fit inside slot 22 of arm 20. In this embodiment, handle 150 provides a hand opening that is much wider than the spacing between the two ends of handle 150 that attach to arm 18. The width of this hand opening is designed to allow comfortable gripping of the handle, and this width was five inches (12.7 cm) in one constructed embodiment, although other widths may be desirable in different embodiments. This additional width is achieved in this embodiment by extending one side of handle 150 into a bight 150A. For practical embodiments it is desirable to expand the width of handle 150 because the support base of handle 150 is typically too narrow for the comfort of users with large hands. It is also desirable to expand handle 150 in a direction away from the end of supporting arm 18. Were one to keep the handle 150 centered on arm 18, it would tend to bring the handle closer to tong 14 so that the handle would be off balance.

Lower arm 30 is the same as before, except that the previously mentioned threaded studs (studs 36) are replaced with studs 54, which are identical to previously mentioned studs 24 and slide inside slot 34″ of lower arm 32″. Also affixed to the arm 30 alongside studs 54 are a pair of posts 56, which are bolt-like members that extend through slot 34″ at a greater distance than studs 54.

Lower arm 32″ is attached to the outside of upper portion 26A of leg 26. Slot 34″ is formed in the longest branch of arm 32″. A bight 32B″ is formed at the proximal end of arm 32″ and reaches to branch 32A″, which again serves to secure one end of spring 40. A C-shaped clip 58 made of spring steel is clipped between the two folds of bight 32B″. In some embodiments, bight 32B″ may be eliminated, so that arm 32″ is more like arm 32 of FIG. 1. With bight 32B″ eliminated, a separate clip assembly may be attached to leg 26 using rivet 33 or other fastening means. This alternate clip assembly can be structured with spring steel to provide the same function as would be provided by clip 58.

A locking lever 60 is shown as a flat steel bar supporting on its distal end a support knob 66. The end of lever 60 opposite knob 66 is pierced with a pivot hole 68. A pivot pin 70 is mounted in hole 68 and held in place with a cotter pin (not shown).

The foregoing arrangement is most convenient for right handed users. To accommodate left-handed users, lever 60 can be mounted on the opposite side by removing arms 30 and 32″. Arm 32″ is removed from leg 26 by releasing fastener 33 (by extracting its cotter pin; see FIG. 2 for a cotter pin installation). Arm 30 will be removed from leg 16 by removing a similar fastener and cotter pin (not shown). Lever 60 will also be removed by removing pivot pin 70, by removing a cotter pin (not shown), and reinstalling lever 60 upside down on arm 32″. Also, knob 66 will be removed from arm 32 and reinstalled on the opposite side of lever 60. Thereafter, arms 30 and 32″ can be reinstalled on the opposite side of the lifter, with the position of spring 40 thereby reversed. Also handle 53 is off-centered and is placed closer to spring 40. Therefore, handle 53 is repositioned by removing bolts 53A and reinstalling the handle in alternate bolt holes 55.

Vertical face of locking lever 60 is shown with four keyhole-shaped notches 72. Each of the notches has a narrow mouth 72A leading to a wider channel 72B. The edges of mouth 72A converges at about a 45° (90° included angle). It will be appreciated that by altering the spacing between jaws 10″ and 12″ posts 56 will slide longitudinally inside slot 34″ to change their position relative to notches 72. With posts 56 appropriately adjusted, locking lever 60 can be swung down using knob 66 so that an adjacent pair of notches 72 will fit around the shanks of posts 56, thereby locking jaws 10″ and 12″ with a fixed spacing. The converging edges of mouth 72A guide posts 56 into channel 72B. Because masonry can vary from their nominal size, the mouth 72A and the channel 72B are made wider than would be strictly necessary if the masonry steps were dimensioned precisely. This widening of notches 72 with respect to the diameter of the shanks of posts 56 provides a tolerance for variations in the size of masonry step 42.

The four notches 72 of lever 60 are designed to handle masonry steps that are either 10, 12, or 14 inches (25, 31, or 36 cm) wide. In alternative embodiments the lever 60 may be dimensioned differently and have a greater or lesser number of notches in order to handle a different number of standard step widths. The overall height of this device, excluding handle 50, is preferably 7½ inches (19.1 cm), although this height may be different in alternate embodiments.

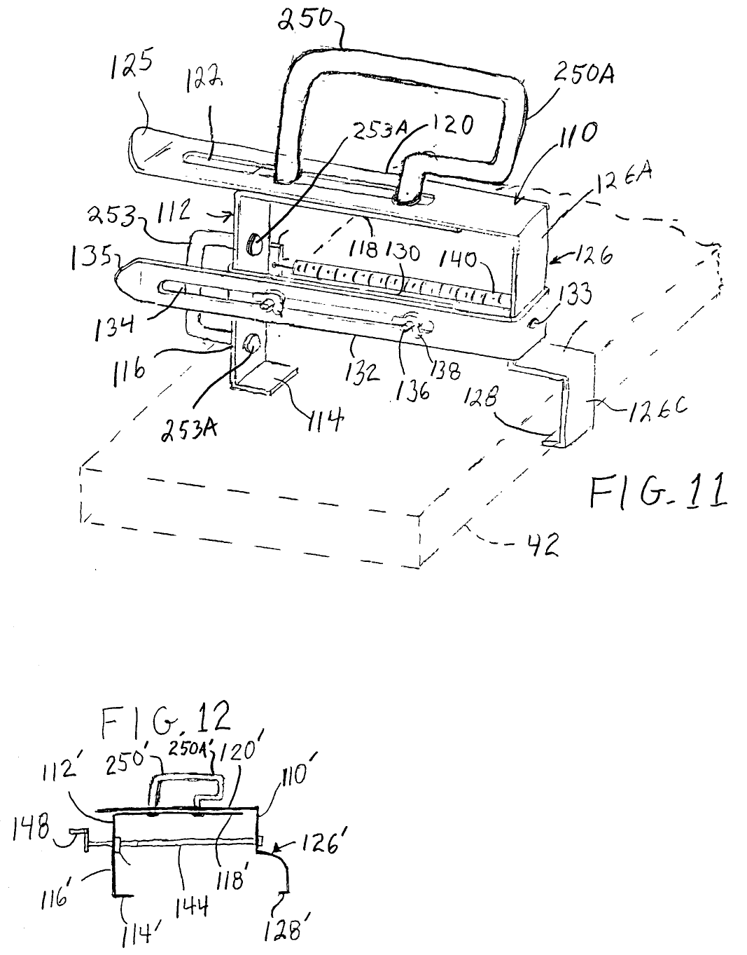

Referring to FIG. 9, the previously mentioned locking lever (lever 60) is replaced with an alternative lever 74 whose distal end terminates in a semi-cylindrical nub 76. Nub 76 is designed to fit in one of a number of semi-cylindrical troughs 78 formed in arm 80. Lever 74 is pivotally attached to one jaw, while the other jaw is attached to arm 80. Nub 76 is locked into one of the troughs 78 by a shackle 82, which is a U-shaped metal clip with rolled ends designed to latch onto arm 80.

Referring to FIG. 11, components that are the same as those shown in FIGS. 1-2 bear the same reference numerals except they are incremented by 100. Accordingly, jaw 112 has a similar J-shaped structure and includes tong 114, straight leg 116, and upper arm 118. An arched handle 253 is attached to the outside of leg 116 by bolts 253A. Handle to 53 is substantially the same as handle 53 of FIG. 5.

The previously illustrated studs (studs 24) are replaced in this embodiment with arched handle 250. Handle 250 is substantially the same as handle 150 shown in FIG. 5. In the same manner as shown in FIG. 4, the two ends of handle 250 are narrowed into studs that fit inside slot 122 of arm 120.

Referring to FIG. 12, components in this schematically illustrated, alternative lifter that correspond to components in the lifter previously illustrated in FIG. 2 have the same reference numerals but incremented by 100. Again, screw 144 is threaded into nut 146, which is secured to leg 116′ of jaw 112′. Jaw 110′ is rotatably secured to one end of lead screw 144. The other end of screw 144 is attached to manual crank 148, which can be rotated to thread the screw 144 through nut 146 and move jaw 110′ relative to jaw 112′. As before, the stock of jaws 10′ and 12′ is preferably 2 inches (5.1 cm) wide and 3/16 inch (4.8 mm) thick.

The previously illustrated handle 50 was replaced in this embodiment with arched handle 250′. Handle 250 is substantially the same as handle 250 shown in FIG. 11. In the same manner as shown in FIG. 4, the two ends of handle 250 are narrowed into studs that fit inside slots in arm 120′.

To facilitate an understanding of the principles associated with the foregoing apparatus, the operation of the lifter of FIGS. 5-8 will be briefly described in connection with the diagrams of FIGS. 10A and 10B. It will be appreciated that the lifters of FIGS. 10A and 10B are illustrated schematically without showing the locking levers, in order to simplify these diagrams.

A mason will build a step foundation F in the usual fashion with horizontal surfaces HS adjacent to vertical surfaces VS. The horizontal surfaces HS will be prepared by first laying down a layer 84 of cement. Next, grasping the lifter of FIG. 5, lever 60 will be raised by lifting knob 66. As the lever 60 rotates, its proximal end will engage and depress spring clip 58 (FIG. 7). Once lever 60 reaches the elevation shown in FIG. 7 spring clip 58 presses against the top edge of lever 60 to hold it in the illustrated elevated position.

The mason may now grasp handle 53 and knob 66 (or grip 26) in order to change the spacing of jaws 10″ and 12″. The jaws may be opened wide so that tongs 14 and 28 can reach around masonry step 42. Once the tongs are positioned below masonry step 42, the mason can release any manual pressure applied to handle 53 and knob 66 so that spring 40 can pull jaws 10″ and 12″ together, allowing tongs 14 and 18 to slip under masonry step 42.

Masonry step 42 typically comes in standard widths of 10, 12, and 14 inches (25, 31, and 36 cm). Therefore, notches 72 are laid out to accommodate these standard widths. Accordingly, lever 60 can be lowered using knob 66 so that the shanks of posts 56 will readily slip into mouth 72A of a pair of the notches 72. The broader channel 72B of notches 72 allow limited movement of posts 56 so that the spacing of jaws 10″ and 12″ can move slightly to accommodate variations in the width of masonry step 42.

In the foregoing manner a pair of lifters can be placed near opposite ends of masonry step 42. For relatively long steps more than two lifters can be employed. Alternatively, where two masons are lifting the masonry step 42, each mason may wish to have a pair of lifters (one for each hand); that is, four lifters altogether.

Next, one or more masons can hoist the lifters by placing one or more hands around handle 150. Masonry step 42 can thus be placed in position on cement layer 84 as shown in FIG. 10A. Because the mason's fingers are not on masonry step 42, it that can be carefully laid in place and not dropped from a small height. Also, because the masons need not place their fingers at the ends of masonry step 42, it can be placed in between flanking walls.

It should be noted that the masonry step 42 is spaced from the adjacent vertical surface VS, and overhangs the horizontal surface HS in the usual fashion. Because leg portion 26A is set back about 2 inches (5.1 cm), there is no interference between the lifter and the overhanging, superior masonry step 42′.

The mason may now lift the locking lever 60, using knob 66. The shanks of posts 56 will slide out of the notches 72. By grasping handle 53 and pushing grip 26, tong 28 will slip out from under masonry step 42, as shown in FIG. 10B. While leg portion 26A moves inwardly, the set back of leg portion 26A avoids interference with the overhanging, superior step 42′. Tong 14 may still remain under masonry step 42 while the mason tilts the lifter and extracts tong 28 between masonry step 42 and vertical surface VS. Alternatively, tongs 14 and 28 can be simultaneously withdrawn from under masonry step 42.

In any event, the set back of leg portion 26A (approximately 2 inches or 5.1 cm) ensures that the lifter can be withdrawn upwardly without interference with overhanging, superior step 42′. Also, tong 28 is relatively short (about ½ in or 1.3 cm) and can easily be extracted in the space between masonry step 42 and vertical surface VS. Once the lifter is removed, the mason can trowel cement into the gap between masonry step 42 and vertical surface VS as shown, for example, in position 86 of FIG. 10A.

This process can be repeated for successively lower levels until masonry steps have been laid on every one of the horizontal surfaces HS of foundation F.

It will be appreciated that the lifters of FIGS. 1, 3, and 9 operate in a similar fashion, except for the manner of setting the jaw spacing. For the embodiment of FIG. 1, the spacing of jaws 10 and 12 is adjusted by loosening wing nuts 38 and sliding jaws together or apart. This sliding is facilitated by studs 24 and 36 sliding in slots 22 and 34, respectively. In order to relatively move the jaws 10 and 12, the mason can grasp leg 16 with one hand and use the other hand to grasp either grip 26 or 35. Once an appropriate jaw spacing is established, the mason can lock the jaws together by tightening wing nuts 38.

For the embodiment of FIG. 3, the mason can adjust the jaw spacing by rotating handle 48 in order to thread lead screw 44 through nut 46. This effectively changes the length of the lead screw 44 between jaws 10′ and 12′ and therefore changes the jaw spacing. Also, the handle 50 can be used to lift the lifter and any masonry step between the jaws 10′ and 12′.

For the embodiment of FIG. 9, arm 74 can be lifted from arm 80 before adjusting the jaw spacing. Thereafter, arm 74 can be lowered so that nub 76 falls into one of the notches 78. Simultaneously, shackle 82 snaps around arm 80 to hold arms 74 and 80 together.

Obviously, many modifications and variations of the present invention are possible in light of the above teachings. It is therefore to be understood that within the scope of the appended claims, the invention may be practiced otherwise than as specifically described.

1. A masonry step lifter comprising:
a first and a second jaw, each having a tong adapted to subjacently support said masonry step, said tongs each having an inwardly directed distal end and a proximal end, each of said first and said second jaw having an arm, said arms of said first and said second jaw overlapping to an adjustable extent and being releasably interlockable, said first jaw having a support leg with a lower portion attached to the proximal end of the tong for said first jaw, said support leg having an upper portion attached to said arm of said first jaw, said upper portion being inwardly set back to provide over the tong of said first jaw clearance for other overhanging masonry steps, said arms of said first and said second jaw being sized to avoid overhanging said upper portion of said support leg.

2. A masonry step lifter according to claim 1 wherein the tongs of said first and said second jaw can be brought together no closer than a predetermined minimum spacing, at said minimum spacing the arm of said second jaw reaching but not passing said leg.

3. A masonry step lifter according to claim 1 wherein said leg has a step portion between said upper and said lower portion of said leg, said upper and said lower portion of said leg having lengths that are transverse to the tong of said first jaw.

4. A masonry step lifter according to claim 3 wherein said step portion is transverse to said lower and said upper portion of said leg.

5. A masonry step lifter according to claim 1 comprising:
a locking lever pivotally attached to one of said first and said second jaw, the other one of said first and said second jaw having at least one post, said locking lever being adapted to releasably lock onto said post to maintain said first and said second jaw with a selected spacing.

6. A masonry step lifter according to claim 5 wherein said locking lever has a plurality of notches sized to engage said at least one lever.

7. A masonry step lifter according to claim 6 wherein each of said notches has a narrow mouth leading to a wider channel to allow a limited freedom of movement for said post in said notch in order to enable said jaws to accommodate dimensional variations in the masonry step.

8. A masonry step lifter according to claim 1 wherein said tongs comprise flat blades, and wherein said arms comprise flat, overlapping bars.

9. A masonry step lifter according to claim 8 wherein said flat bars overlap along a plane parallel to said flat blades.

10. A masonry step lifter according to claim 9 comprising:
at least one stud affixed to one of the said bars, the other one of said bars having a slot slidably embracing said stud.

11. A masonry step lifter according to claim 8 wherein said flat bars overlap along a plane perpendicular to said flat blades.

12. A masonry step lifter according to claim 11 comprising:
at least one stud affixed to one of said flat bars, the other one of said flat bars having a slot slidably embracing said stud.

13. A masonry step lifter according to claim 12 comprising:
a wing nut threaded onto said stud.

14. A masonry step lifter according to claim 1 comprising:
yielding means coupled between said first and said second jaw for urging them together.

15. A masonry step lifter according to claim 1 wherein said second jaw has a straight back leg connected between the tong and the arm of said second jaw.

16. A masonry step lifter according to claim 1 wherein the arm of said first jaw has a distal hand grip.

17. A masonry step lifter according to claim 1 comprising:
a handle coupled to at least one of said first and said second jaw for lifting them.

18. A masonry step lifter according to claim 17 wherein said handle is extended in a direction to improve handle balance during lifting.

19. A masonry step lifter according to claim 1 comprising:
a shackle affixed to the arm of a given one of said first and second jaws, the arm of the other one of said first and second jaws being releasably and adjustably coupled to said shackle, said shackle being released by displacing the arms of said first and said second jaws at said shackle in order to reposition said shackle along the arm of said other one of said first and said second jaws.

20. A masonry step lifter comprising:
a first and a second jaw, said first and said second jaws being releasably interlockable, each having a tong adapted to subjacently support said masonry step, each of said first and said second jaw having an upper and a lower arm, said upper arms of said first and said second jaws overlapping to an adjustable extent, said lower arms of said first and said second jaws overlapping to an adjustable extent.

21. A masonry step lifter according to claim 20 wherein said lower arms of said first and said second jaws are between said tongs and said upper arms.

22. A masonry step lifter according to claim 21 wherein said lower arms of said first and said second jaws are closer to said tongs than said upper arms.

23. A masonry step lifter according to claim 20 wherein said tongs each have an inwardly directed distal end and a proximal end, said first jaw having a support leg with a lower portion attached to the proximal end of the tong for said first jaw, said support leg having an upper portion attached to said upper and said lower arm of said first jaw, said upper portion inwardly set back to provide over the tong of said first jaw clearance for other overhanging masonry steps.

24. A masonry step lifter according to claim 23 wherein the tongs of said first and said second jaw can be brought together no closer than a predetermined minimum spacing, at said minimum spacing the upper and the lower arm of said second jaw reaching but not passing said support leg.

25. A masonry step lifter according to claim 23 wherein said leg has a step portion between said upper and said lower portion of said leg, said upper and said lower portion of said leg having lengths that are transverse to the tong of said first jaw.

26. A masonry step lifter according to claim 25 wherein said step portion is transverse to said lower and said upper portion of said leg.

27. A masonry step lifter according to claim 20 comprising:
a locking lever pivotally attached to one of said first and said second jaw, the other one of said first and said second jaw having at least one post, said locking lever being adapted to releasably lock onto said post to maintain said first and said second jaw with a selected spacing.

28. A masonry step lifter according to claim 27 wherein said locking lever has a plurality of notches sized to engage said at least one lever.

29. A masonry step lifter according to claim 28 wherein each of said notches has a narrow mouth leading to a wider channel to allow a limited freedom of movement for said post in said notch in order to enable said jaws to accommodate dimensional variations in the masonry step.

30. A masonry step lifter according to claim 20 wherein said tongs comprise flat blades, and wherein said upper and said lower arms comprise flat, overlapping bars.

31. A masonry step lifter according to claim 30 wherein said flat bars of said upper arms overlap along a plane parallel to said flat blades.

32. A masonry step lifter according to claim 31 comprising:
at least one stud affixed to the flat bar of one of said upper arms, the other one of said upper arms having a slot slidably embracing said stud.

33. A masonry step lifter according to claim 30 wherein said flat bars of said lower arms overlap along a plane perpendicular to said flat blades.

34. A masonry step lifter according to claim 33 comprising:
at least one stud affixed to one of said flat bars of said lower arms, the other one of said lower arms having a slot slidably embracing said stud.

35. A masonry step lifter according to claim 34 comprising:
a wing nut threaded onto said stud.

36. A masonry step lifter according to claim 20 comprising:
yielding means coupled between said first and said second jaw for urging them together.

37. A masonry step lifter according to claim 20 wherein said second jaw has a straight back leg connected between the tong and the upper arm of said second jaw.

38. A masonry step lifter according to claim 20 wherein the upper and the lower arm of said first jaw each have a distal hand grip.

39. A masonry step lifter according to claim 20 comprising:
a handle coupled to at least one of said first and said second jaw for lifting them.

40. A masonry step lifter according to claim 39 wherein said handle is extended in a direction to improve handle balance during lifting.

41. A masonry step lifter according to claim 20 comprising:
a shackle affixed to the lower arm of a given one of said first and second jaws, the arm of the other one of said first and second jaws being releasably and adjustably coupled to said shackle, said shackle being released by displacing the lower arms of said first and said second jaws at said shackle in order to reposition said shackle along the arm of said other one of said first and said second jaws.

42. A method for laying a masonry step with first and second spatially adjustable jaws onto a stepped foundation having an alternating plurality of horizontal and vertical surfaces, each of the jaws having a lower tong, the method comprising the steps of:
straddling said masonry step with said jaws;
bringing said jaws together in order to insert said tongs under said masonry step;
lifting said jaws to raise said masonry step;
using said jaws to lay said masonry step on one of said horizontal surfaces with an inward one of said tongs close to an adjacent one of said vertical surfaces;
separating said jaws to remove at least the inward one of said tongs from under said masonry step; and
lifting at least the inward one of said tongs.

43. A method according to claim 42 comprising the step of:
locking said jaws to prevent jaw separation before lifting said jaws to raise said masonry step.

44. A method according to claim 42 wherein the step of using said jaws to lay said masonry step is performed by laying said masonry step with an upper portion of said inward one of said jaws setback from the adjacent one of said vertical surfaces in order to provide clearance for another masonry step overhanging the adjacent one of said vertical surfaces.
